(19) United States
(12) Patent Application Publication
(10) Pub. No.: US 2017/0178311 A1
(43) Pub. Date: Jun. 22, 2017

(54) MACHINE FAULT DETECTION BASED ON A COMBINATION OF SOUND CAPTURE AND ON SPOT FEEDBACK

(71) Applicant: PROPHECY SENSORS, LLC, BALTIMORE, MD (US)

(72) Inventor: Biplab Pal, Ellicott City, MD (US)

(73) Assignee: Prophecy Sensors, LLC, Baltimore, MD (US)

(21) Appl. No.: 15/065,896

(22) Filed: Mar. 10, 2016

Related U.S. Application Data
(60) Provisional application No. 62/269,994, filed on Dec. 20, 2015.

(51) Int. Cl. G06T 7/00; G01H 11/06; H04W 4/00; G06N 5/04; G06N 99/00

(52) U.S. Cl. CPC G06T 7/0004; G06N 5/046; G06N 99/005; H04W 4/008; G01H 11/06; G06T 2207/30164

(57) ABSTRACT

A method and system of on spot diagnosis of one or more issues associated with a machine includes collecting sound data and image data associated with a machine through a mobile device and transmitting them to a cloud server over a communications network. The on spot diagnosis includes analyzing the sound data and image data in combination with an on spot feedback system through the cloud server. The on spot feedback system is communicatively coupled to a machine-learning engine and a Big Data architecture. The machine issue condition is indicated through a user interface dynamic such a circular gauge. An alarm is set, through a mobile device, for the machine issue.

### CROSS-REFERENCE TO RELATED APPLICATION

This application claims priority to the U.S. Provisional Patent application No. 62/269,994 filed in the United States Patent and Trademark Office on Dec. 20, 2015, entitled “Predictive Maintenance for On-Spot Diagnosis Using Mobile Application”. The specification of the above referenced patent application is incorporated herein by reference in its entirety.

### FIELD OF TECHNOLOGY

The present invention generally relates to mobile-based machine fault diagnosis. More specifically, it relates to fault detection in a machine through a combination of on spot feedback and mobile phone based sound capture.

### BACKGROUND

While mobile applications revolutionized human lifestyles with emergence of cost effective and powerful smart-phones, its impact on manufacturing has yet to be felt in a considerable way. Previously, every instrument and sensor mounted on machines and process lines worked on wireline industrial buses connected to a human machine interface (HMI). Given that the majority of sensorial data was also required for effective control of the process, which needs more reliable communication protocols that are not available via wireless communication pipe, a smartphone never found its way into a manufacturing plant except for a few newly designed sensors. Specifically, while numerous mobile applications found ubiquitous use in daily life, for manufacturing, its use was still limited and insignificant.

Typically industrial acoustic sensors use up to 40 KHz audio band (in ultrasound) for fault diagnosis. Mobile smartphones detect up to 20 KHz audible range. Smartphone uses many specialized encoders for voice spectrum that tend to squeeze data within 5 KHz voice range. Therefore, use of smartphone's inbuilt audio capturing device is never ideal for fault detection of machines if only the spectrum of the sound wave is used for the diagnosis.

Prior non-patent literatures have described ways of sound analysis that are deeply entrenched in the Fast Fourier Transform (FFT) of sound and then detecting the harmonics.

Some of the prior non-patent literature discloses vibration analysis as a popular technique in predictive maintenance of machines. Predictive Maintenance (PM) may be a maintenance philosophy that is designed to predict when maintenance work needs to be performed to prevent premature failure of a machine. PM is an effective maintenance strategy that not only saves cost of maintenance, but also prevents possible failure of a machine because conventional maintenance is performed only when a possible functional failure is detected.

Vibration analysis is not always a practical solution for detecting faults. Equipment, installation, and periodic or continuous monitoring and analyzing of vibration analysis system can be expensive or logistically prohibitive. In addition, vibration analysis can be inaccurate in a complex machine due to distortions caused by surrounding vibration from other parts of the machine. Some non-patent literatures have also disclosed techniques that use a sound band beyond 20 KHz.

US 20150039250 A1 relates to a detection system configured to capture acoustic information and contextual information related to a machine component defect. However, the detection system generates an acoustic fingerprint based at least in part on one or more characteristic features of the acoustic information, such that the one or more characteristic features correspond to the machine component defect.

WO 2014085648 A1 relates to utilizing ultrasound emissions for fault detection in industrial equipment. However, the basis of the application lies in identifying outliers in sound data.

WO 2014117245 A1 relates to systems and methods for predicting failures or performance issues that may be configured for gaming machines and systems.

WO 2015022036 A1 relates to systems and methods for separating sound arriving from an object of interest and its background and a condition monitoring system and a mobile phone using the same.

US 20130268469 A1 relates to prediction models and, more particularly, a technique of increasing signal to noise ratio for creation of generalized and robust prediction models.

However, none of the prior arts suggest the use of a sound band below 20 KHz for on spot diagnosis of machine faults. Also, the prior arts fail to show utilization of any combination of on spot feedback and sound capture to diagnose a machine fault.

It is evident from the discussion of the aforementioned prior arts that none of them paves a way for use of a combination of on spot feedback systemobile phone based sound anchor image capture for machine fault diagnosis.

### SUMMARY OF THE INVENTION

Disclosed are a method, an apparatus and/or system of mobile application for on-spot machine fault diagnosis.

In one aspect, the present invention relates to a method of on-spot machine fault diagnosis through a mobile application. This includes capturing sound and image data associated with a machine through a mobile device as well as collecting sound and image data onto the mobile application associated with the mobile device. Further, the method includes transmitting the sound and image data through the mobile application to a cloud server over a communications network and analyzing the sound and the image data in combination with an on spot feedback system through the cloud server. The on spot feedback system is associated with a machine-learning and a Big Data architecture. A result of the analysis may be sent to the mobile application associated with the mobile device.

In another aspect, the present invention relates to a method of on spot diagnosis of one or more issues associated with a machine, which includes collecting (through a mobile device) sound data associated with a machine and transmitting (over a communications network) the sound data to a cloud server. Any problems with the machine are determined by an analysis of a combination of collected sound data and an on spot feedback system. The on spot feedback system is associated with a Big Data engine and a machine-learning engine. Indication of issues with the machine are displayed through a user interface dynamic with the mobile device. An alarm is set, through a mobile device, for the machine issue.

The methods and systems disclosed herein may be implemented in any means for achieving various aspects of intended results and may be executed in a form of a machine-readable medium embodying a set of instructions that, when executed by a machine, cause the machine to perform any of the operations disclosed herein. Other features will be apparent from the accompanying drawings and from the detailed description that follows.

### BRIEF DESCRIPTION OF THE DRAWINGS

The embodiments of the present invention are illustrated by way of example and not as limitation in the figures in which similar elements are indicated with same references.

FIG. 1 is a diagrammatic representation of an overall process of on spot diagnosis, according to one embodiment.

FIG. 2 is a diagrammatic representation of a data processing system capable of processing a set of instructions to perform any one or more of the methodologies herein, according to one embodiment.

FIG. 3 is a process flow diagram detailing the operations of a method of on-spot machine fault diagnosis through a mobile application, according to one or more embodiments.

FIG. 4 is a diagrammatic representation of a circular gauge to depict a state of machine failure, according to one example embodiment.

FIG. 5 shows storage of machine condition information using an example of a machine with an actuator and motor, according to one embodiment.

FIG. 6 is a snapshot showing baseline and training data collection, according to one or more embodiments.

FIG. 7 shows a feedback option to adjust gauge value, according to one embodiment.

Other features of the present embodiments will be apparent from the accompanying drawings and from the detailed description that follows.

### DETAILED DESCRIPTION

Example embodiments as described below may be used to provide a method, an apparatus and/or a system for mobile application based on spot diagnosis of machine faults. Although the present embodiments have been described with reference to specific example embodiments, it will be evident that various modifications and changes may be made to these embodiments without departing from the broader spirit and scope of the various embodiments.

Described herein is a mobile application based method for on spot diagnosis of machine faults. The method may not be dependent on a sensor but rather the capability of a smartphone to capture high-resolution sound and images.

In one or more embodiments, as users pass by machines that produce noise, the users may be able to stop by a machine and get an idea of the health of the machine and source of the machine's ailment within two minutes in a systematic way via a mobile application. The mobile application may capture one or more sound bites from the machine and sends the sound bites to a cloud server for analysis. The cloud server may run advanced machine-learning software that recognizes the sound and identifies any issues, if any. Continuous use of the mobile application may show a gradual shift of the condition of the machine. Users may have the ability to field calibrate results for improving accuracy of detection of the state of failure adaptively over time.

Mobile applications associated with diagnosis of a machine condition based on sound suffer from various issues. Some of the major issues are inability to eliminate background noise and an inadequate sound spectrum for a mobile phone/device. An on spot feedback system associated with the mobile application resolves these aforementioned issues associated with mobile applications. The on spot feedback system may include a scoring mechanism to receive inputs for a score of a machine failure. The on spot feedback system may utilize the scoring mechanism to eliminate background noise and inadequacy of spectrum. The scoring mechanism may be communicatively coupled to a machine-learning engine and a Big Data architecture. The machine-learning engine may be coupled to the on spot feedback system. The on spot feedback system may utilize a human input to continually course correct and learn. The continuous course correction and learning may be in association with the machine-learning engine. The learning and continuous course correction may lead to a state where majority of the background noise is eliminated and makes up for the inadequacy in sound spectrum range for the mobile phone/device.

In one or more embodiments, collected sound and/or image data may be analyzed in combination with the on spot feedback system to detect and diagnose a machine fault.

Typically, industrial acoustic sensors may use up to 40 KHz audio bands (in ultrasound) for fault diagnosis. Mobile smartphone may detect up to 20 KHz audible range. The smartphone may use specialized encoders for voice spectrum that tend to squeeze data within a 5 KHz voice range. Therefore, described herein is a new method for completing fault diagnosis that may use the limited audio-spectrum of the smartphone and yet can be accurate beyond 90% in predicting failure of machines. Deep learning techniques and machine-learning techniques used herein may emulate the human understanding of sound instead of old ways of sound analysis that are deeply entrenched in Fast Fourier Transform (FFT) of sound and then detecting the harmonics.

In addition to sound, the mobile application may also allow capture of images of a filter and other parts that show visible degradation. The mobile application is capable of quantifying such degradation through image processing. Such quantification may be upgraded to a systematic MRO (maintenance, repair, and operation) view over a larger number of observations.

In one or more embodiments, the mobile application may be able to detect oil viscosity, oil level, filter clogging, and belt tension in a comprehensive way.

Techniques described herein may include variance, kurtosis, percentile and crest factor (maximum value/RMS value of a periodic signal).

In one or more embodiments, a mobile application in association with a mobile device or a smartphone may be used for collecting data associated with a machine. The data collected may be in structured and/or un-structured format. For example, audio data may be in an un-structured format. Data may be collected with primary meta-data classification such as “baseline” and “test” where baseline refers to normal operating condition and/or a condition referring to a good machine and test data may be classified according to the need of the testing.

The mobile application data may be fed to a cloud server. The cloud server may collect, analyze and store the sensor data using Big Data technology such as Kafka, NoSql, Cassandra and Apache Spark. The cloud server may in turn be associated with a machine-learning engine.

Machine-learning may be a part of artificial intelligence. Intelligence in machines may be developed by developing algorithms that may learn from data over time and improve the predictions accordingly. Two widely used machine-learning methods are supervised and un-supervised learning methods. To analyze and predict the machine faults both supervised and un-supervised learning methods may be used.

In an example embodiment, a user may need to identify whether a machine is operated abusive manner or not. In terms of machine-learning, it can be formulated as binary and/or multiclass supervised classification problem where the objective is to classify whether the pressure at which the machine is being operated is normal or abusive.

The data collected from the mobile application may be directional and/or non-directional data.

The data may be high volume data and a solution may be needed to be delivered in near real time, so the data is also high velocity. As discussed, the data can be structured, un-structured and audio data.

In one or more embodiments, a motor may be needed to be operated in a particular speed range. When the speed range increases, the pressure at which the motor is operating also increases, leading to faults in the motor.

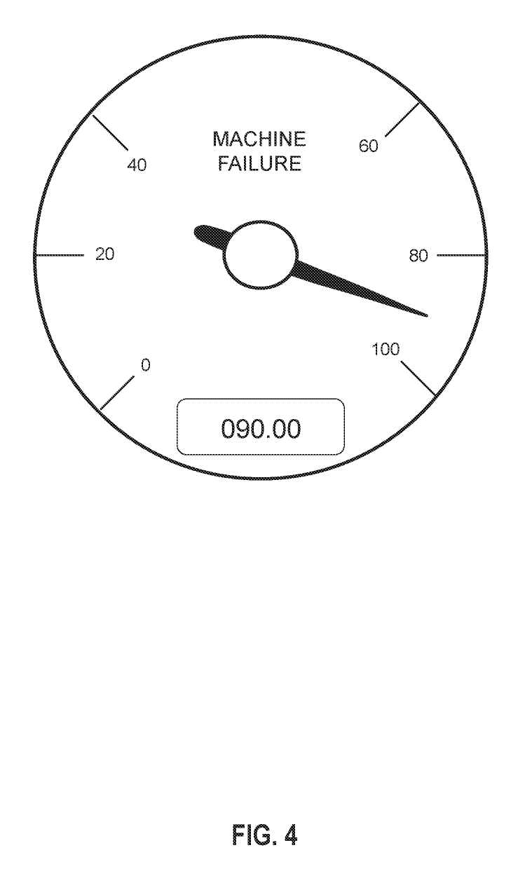

FIG. 4 shows a circular gauge depicting machine failure, according to one embodiment. In one approach, results may be mapped into a simple “Circular Gauge” with a normalized scale of 0 to 100. A user may set scales for setting up an alarm and scaling up predictive maintenance issue on the machine. Thus, complex results of Big Data analytics associated with machine may be visualized by applying the techniques disclosed herein.

The results may be visualized through user interface dynamic associated with the mobile application. The mobile application may be associated with a smartphone and/or a tablet computer.

In one or more embodiments, “Big Data” may be a term used to refer to large data sets. The data sets may be so large and complex that traditional data processing systems may be inadequate to handle them. The data collected with the mobile application may be extremely large and complex. The data may be collected onto a Big Data server over a cloud. The Big Data server may refer to distributed one or more servers associated with the mobile application.

In one or more embodiments, data may be collected with primary meta-data classification such as “Baseline” and “Test”, where baseline refers to normal operating condition and/or a condition referred to a healthy machine. Test data may be classified according to the need of testing. Historical statistics—such as energy consumption of different loads, machines, shifts, etc. —may be tracked using an energy efficient mechanism.

In one or more embodiments, a communication network may be WiFi, 2G, 3G, 4G, GPRS, EDGE, Bluetooth, ZigBee, Piconet of BLE, Zwave or a combination thereof.

In one or more embodiments, the machine-learning engine may be associated with a machine-learning algorithm.

In an example embodiment, a depiction on a user interface may be a circular gauge type representation as shown in FIG. 4.

Further, the circular gauge may be associated with color schemes such as red, yellow and green. In an exemplary embodiment, the color scheme red may indicate an alarming machine condition, yellow may indicate an impending machine issue and green may indicate a healthy machine.

In one or more embodiments, an alarm may be raised when color scheme is either yellow or red.

In one or more embodiments, the machine-learning engine may be associated with a machine-learning algorithm. The machine-learning engine may be capable of receiving machine data from a mobile application and/or cloud server. The machine-learning engine may process the received data to recognize a pattern and/or a deviation to issue an alarm and control commands pertaining to the machine in association with the communications network.

Further, the machine-learning engine may be associated with a multi-classification engine such as an oblique and/or support vector machine. The support vector machines may be supervised learning models with associated learning algorithms that analyze data and recognize patterns. Supervised learning models may be used for classification and regression analysis.

In one or more embodiments, steps of the multi-classification engine may include data transformation to achieve maximum separation among fault types. The data transformation may lead to more accurate multi classification (e.g. linear discriminant functions). Further, nonlinear hyperplane fitting may be done to classify different fault types (e.g. quadratic hyperplanes in transformed variable space). A measure is being developed to represent the degree of fault based on machine-learning multi-fault classification approach. The intensity of fault may be calculated (e.g. posterior probability of fault type). The degree of fault information may be mapped onto the circular gauge such as in FIG. 4. For example, different fault type posterior probabilities may be combined to get the circular gauge representation. User calibration of the circular gauge may be enabled to include user intuition about the machine state into the analytics process. The multi classification may end when the user agrees with the circular gauge.

In one or more embodiments, a mobile application based on-spot machine diagnosis system may utilize Big Data visualization associated with one or more circular gauges to simplify issues and alarms associated with rotor driven equipment.

The rotor driven equipment diagnosis system may include two layers, first front layer being a gauge (single, multi-parametric or multi-dimensional) and second layer being analytical. A user may set an alarm for machine issues such as oil state, oil level, high belt tension, etc., based on direct rules and/or multi-classification machine-learning algorithm using a Base-Line (BL) calibration method.

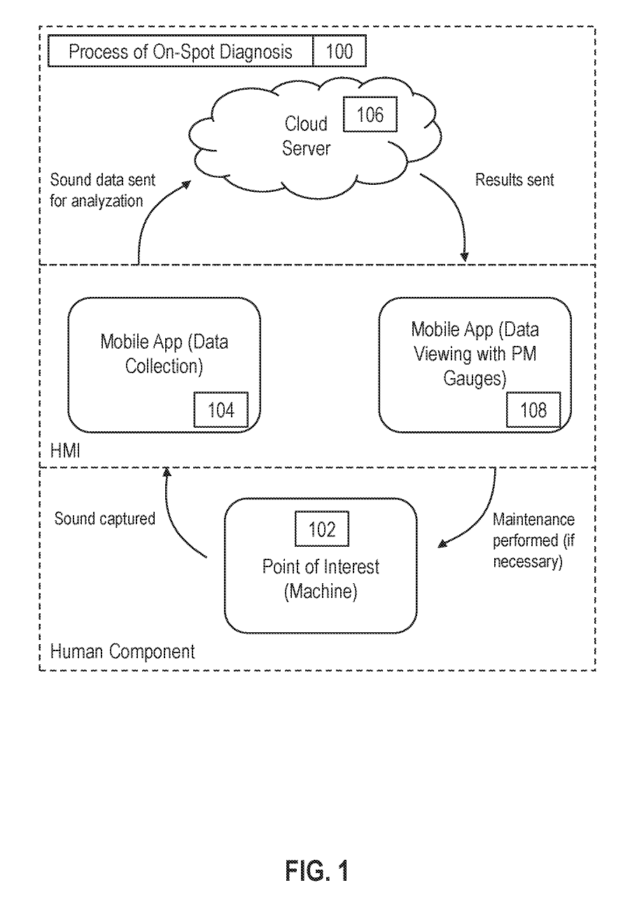

FIG. 1 is a diagrammatic representation of an overall process of on spot diagnosis, according to one embodiment. A method of on spot machine fault diagnosis through a mobile application 100 may include capturing sound and image data associated with a machine through a mobile device 102 and collecting sound and image data onto the mobile application associated with the mobile device 104. Further, the method includes transmitting (over a communications network) sound and image data through the mobile application to a cloud server and analyzing them through the cloud server in association with a machine-learning and Big Data architecture 106. A result of the analysis may be sent to the mobile application associated with the mobile device 108.

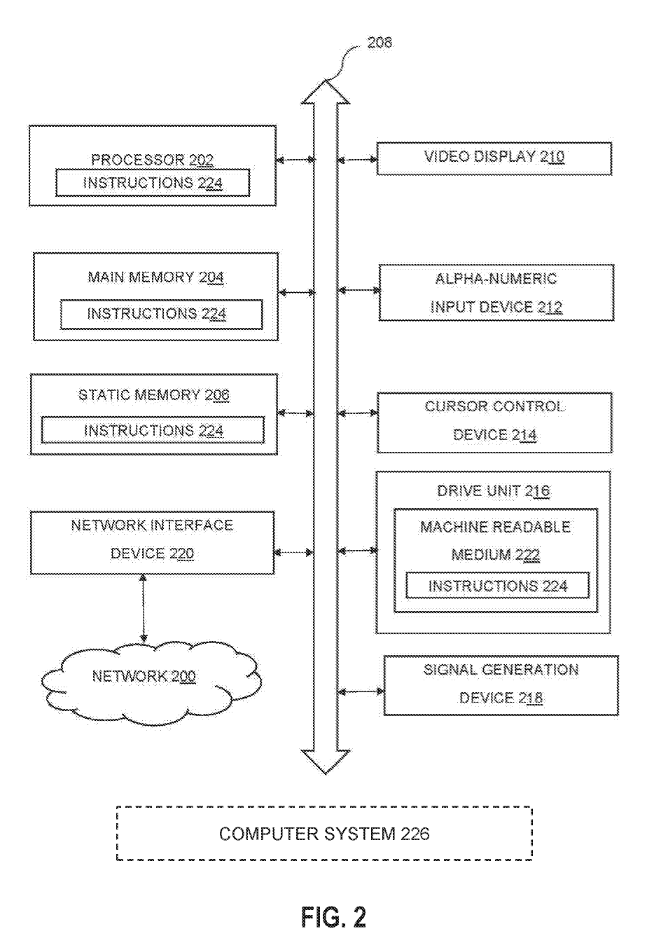

FIG. 2 is a diagrammatic representation of a data processing system capable of processing a set of instructions to perform one or more of the methodologies herein, according to an example embodiment. FIG. 2 shows a diagrammatic representation of machine as an example of a computer system 226 within which a set of instructions for causing the machine to perform any one or more of the methodologies discussed herein, may be executed. In various embodiments, the machine operates as a standalone device and/or may be connected (e.g. networked) to other machines.

In a networked deployment, the machine may operate in the capacity of a server and/or a client machine in server-client network environment and/or as a peer machine in a peer-to-peer (or distributed) network environment. The machine may be a Personal Computer (PC), tablet PC, Set-Top Box (STB), Personal Digital Assistant (PDA), cellular telephone, web appliance, network router, switch and/or bridge, embedded system and/or any machine capable of executing a set of instructions (sequential and/or otherwise) that specify actions to be taken by that machine. Further, while only a single machine is illustrated, the term “machine” shall also be taken to include any collection of machines and/or sub-assemblies that individually or jointly execute a set (or multiple sets) of instructions to perform one and/or more of the methodologies discussed herein.

For example, computer system 226 includes a processor 202 (e.g. a central processing unit (CPU) or a graphics processing unit (GPU) or both), main memory 204 and static memory 206, which communicate with each other via a bus 208. The computer system 226 may further include a display unit 210 (e.g. a liquid crystal displays (LCD) and/or a cathode ray tube (CRT)). The computer system 226 also includes an alphanumeric input device 212 (e.g. a keyboard), cursor control device 214 (e.g. a mouse), disk drive unit 216, signal generation device 218 (e.g. a speaker) and network interface device 220.

The disk drive unit 216 includes a machine-readable medium 222 on which is stored one or more sets of instructions 224 (e.g. software) embodying any one or more of the methodologies and/or functions described herein. The instructions 224 constituting machine-readable media may also reside completely or at least partially, within the main memory 204 and/or within the processor 202 during execution thereof by the computer system 226, main memory 204 and processor 202.

The instructions 224 may further be transmitted and/or received over a network 200 via the network interface device 220. While the machine-readable medium 222 is shown in an example embodiment to be a single medium, the term “machine-readable medium” should be taken to include a single medium and/or multiple media (e.g. a centralized and/or distributed database, and/or associated caches and servers) that store the one or more sets of instructions. The term “machine-readable medium” shall also be taken to include any medium that is capable of storing, encoding and/or carrying a set of instructions for execution by the machine and that cause the machine to perform any one or more of the methodologies of the various embodiments. The term “machine-readable medium” shall accordingly be taken to include, but not be limited to solid-state memories, optical and magnetic media, and carrier wave signals.

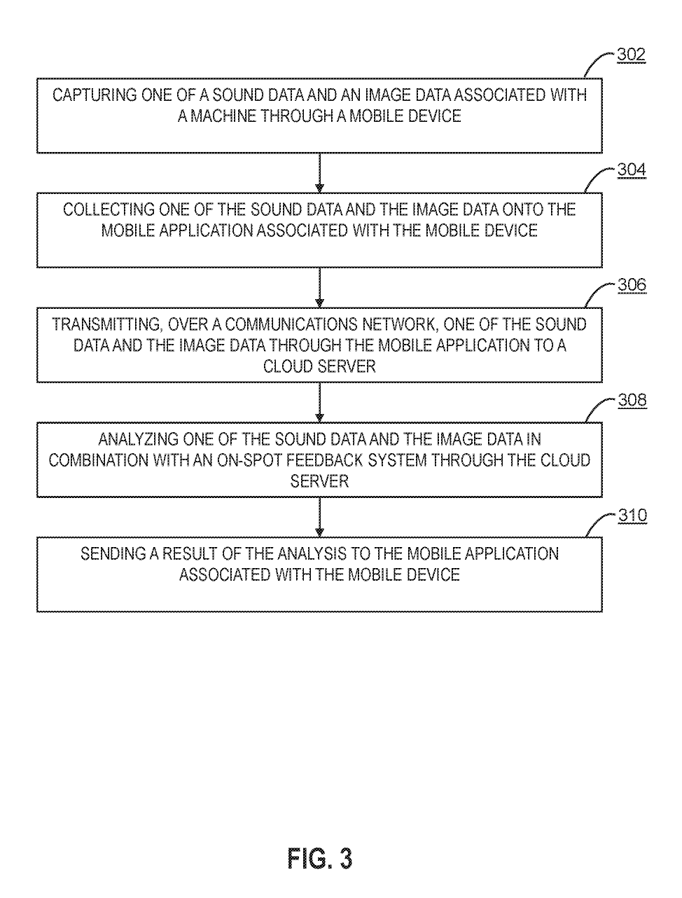

FIG. 3 is a process flow diagram detailing the operations of a method of on spot machine fault diagnosis through a mobile application including capturing sound and image data associated with a machine through a mobile device 302 and collecting sound and image data onto the mobile application associated with the mobile device 304. Further, the method includes transmitting sound and image data over a communications network through the mobile application to a cloud server 306 and analyzing that data through the cloud server in association with machine-learning and Big Data architecture 308. A result of the analysis may be sent to the mobile application associated with the mobile device 310.

FIG. 4 is a diagrammatic representation of a circular gauge to depict a state of a machine failure, according to one example embodiment.

In an example embodiment, data may be collected from diverse locations such as 10,000 factory locations for 3P (prescriptive, preventative and predictive) maintenance by using a combination of Cassandra (distributed database), Storm and/or Spark real time. To process the data in a real time, Big Data architecture uses a broker system, such as Kafka, for storing the alarms as buffer database and then uses a Storm and/or Cassandra distributed database for an MRO (Maintenance, Repair and Operation) system. The real time Big Data architecture may be associated with the cloud server.

In one or more embodiments, 3P maintenance may be a possibility for a machine. Big Data methodologies may be employed to analyze data obtained from various locations through multiple mobile applications on multiple smartphones. Big data may be used to describe a massive volume of both structured and unstructured data. Large volumes of data may be difficult to process using a traditional database and traditional software techniques. Therefore, a distributed real-time computation system such as Apache Storm may be used for distributed rotor driven equipment diagnosis.

In one or more embodiments, an alarm may be set through a rule based engine and a multi-classification machine-learning engine.

In one or more embodiments, the communication network is one of Wi-Fi, 2G, 3G, 4G, GPRS, EDGE, Bluetooth, ZigBee, Piconet of BLE, Zwave or a combination thereof.

In one or more embodiments, an alarm may be raised over the communication network, through a notification on the mobile application, Short Message Service (SMS), email or a combination thereof.

A predictive maintenance circular gauge may be associated with one or more color indications. The color indications may include red, yellow and green. The red may indicate a danger mode of operation wherein the machine may comprise one of the failed states and/or the machine is about to fail. The yellow may indicate an intermediate state of operation for the machine associated with the predictive maintenance gauge. The green may indicate an ideal and/or smooth state of operation for the machine associated with the predictive maintenance circular gauge.

In one or more embodiments, an alarm may be raised when color scheme is either yellow or red.

In one or more embodiments, mobile application may be enabled to compute through a computation engine. Computation engine may be associated with calculation of one or more of kurtosis, crest factor, and percentile.

In one or more embodiments, an alarm may be raised when color scheme is yellow or a red.

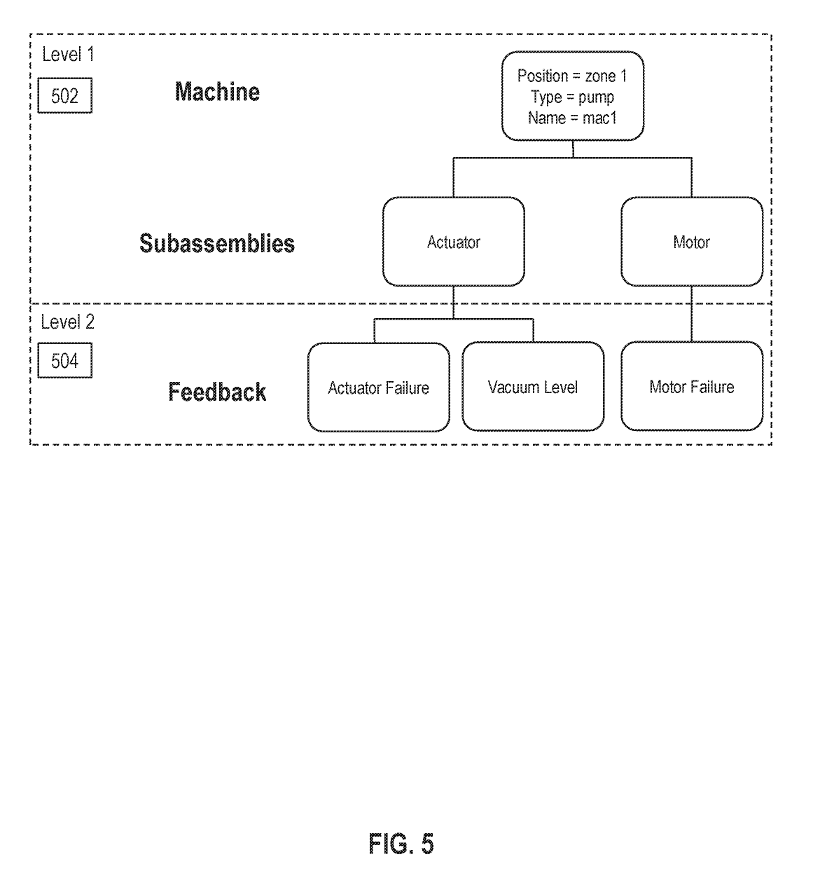

FIG. 5 shows storage of machine condition information using an example of a machine with an actuator and motor, according to one embodiment. A mobile application may be a tool for maintenance personnel to provide his/her assessment of a machine condition in a systematic way by providing feedback. The user may be provided a machine condition information through two layers of database. In level 1 502, the machine's position, type, name, and subassemblies may be stored. The machines and subassemblies may be defined by the user. Machines may be defined as collections of subassemblies. Subassemblies may be common components in various machines that are well known to an algorithm. The subassemblies may include the actuator, belt, blower, cutter, gearbox, rotor, and motor. The level 2 504 may contain feedback on known issues of the subassemblies.

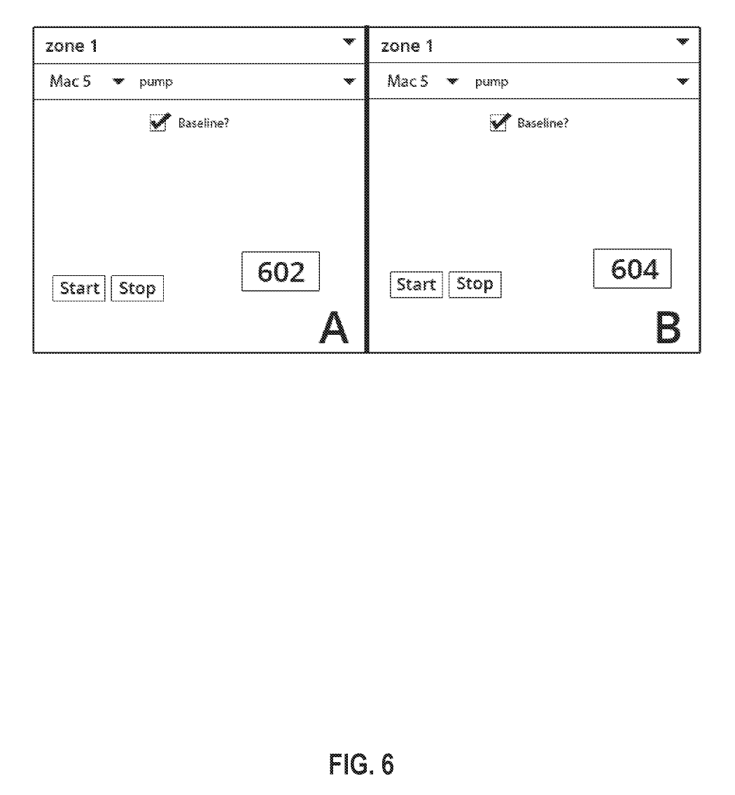

FIG. 6 is a snapshot showing baseline and training data collection, according to one or more embodiments. Feedback is a two way street between a user and a deep learning algorithm. First, baseline data may be collected. Baseline means when subassemblies of a machine are in a good condition. Baseline may be a point of reference against which faulty states of the subassemblies are compared for accurate diagnosis of faults. To collect baseline data, maintenance personnel may specify a machine, select “baseline” on the mobile application and collect sound data 602. An automatic notification may be raised when baselining is complete. The next stage may be training data collection. To collect training data, the machine is specified and sound data 604 may be collected. For field learning, data may be collected over months so that gradual degradation of the machine condition from baseline can be recorded.

Gauges representing the predicted values of subassembly failure modes may be displayed based on collected data. The gauges display severity of a problem on a scale from 0 to 100, with 100 being most severe. Gauges are divided into green, yellow, red sections; green being the safe/normal operational condition, yellow being the borderline to unsafe operational condition, and red being the unsafe operational condition that requires maintenance.

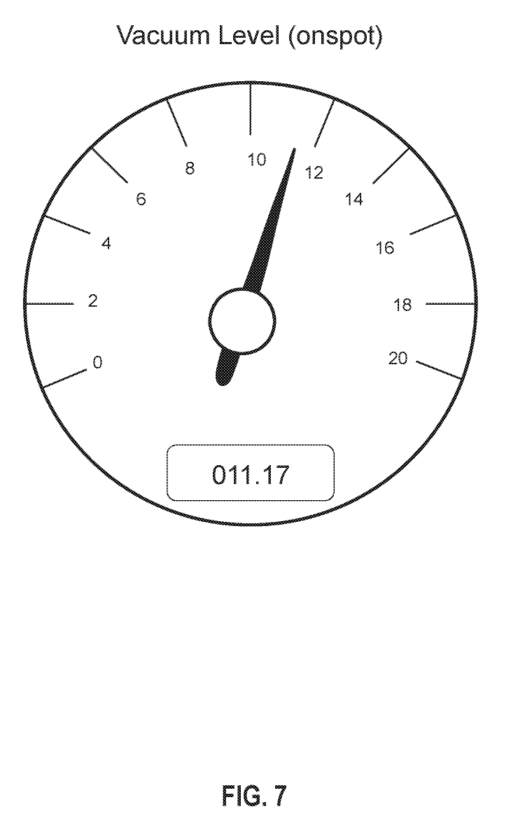

FIG. 7 shows a feedback option to adjust gauge value, enter in correct value and select “FEEDBACK”, according to one embodiment. There may be a gauge for each subassembly failure mode. Once the deep learning algorithm updates the gauges with the prediction, maintenance personnel may adjust a value on the scale based on knowledge of the machine condition. For example, if a user collects data for a run for an oil fill just under optimal fill and an “Oil Level” gauge reads “90” (severe problem), then the maintenance personnel may adjust that value to “70” (beginning of a failure) and/or another value that may accurately represent the machine condition. Training data may be a combination of healthy and faulty information about the machine.

In one or more embodiments, sound data may be continually stored once baseline begins. The training data and feedback process is continued until the learning system gets enough data for training. A notification may be sent to a user when gauges are ready for implementation. Once gauges have been implemented, sound data taken will update gauges to accurately display the conditions of the subassemblies and corrective maintenance work may be performed when necessary.

In one or more embodiments, on spot diagnosis may minimize human intervention. When first setting up an on spot diagnosis system, users may define a machine to examine by selecting pre-defined subassemblies which are components of the machine. An algorithm may have a subassembly bank with details of the issues and classifications for the subassemblies. The bank of subassembly information allows users to bypass the step of identifying potential failures within the machine. Each failure gets a gauge representation based on a severity for the user to examine. The sound data collected may be sent to a cloud server for analysis and storage of data. Once training data collection begins, accuracy of deep learning classification algorithm may be calculated. The calculation may continue until desired accuracy is reached at which time there is a notification that a PM gauge is ready for implementation.

In one or more embodiments, each subassembly may have an associated automated algorithm for issues and classifications. Once the algorithm receives a sufficient amount of training data, the algorithm automatically calculates the classification accuracy.

In one or more embodiments, on spot diagnosis mobile application may also be capable of identifying visible degradation of a subassembly using image processing. The process is same as collecting sound data, except, images are collected instead of sound.

In one or more embodiments, a mobile application system working with Big Data analytic server may classify machine sound using advanced machine-learning algorithm, such as deep learning, where the learning system is driven by a system of a subassembly database and feedback from the maintenance personnel.

In one or more embodiments, a feedback HMI in the mobile application may allow simple assessment of machine condition using a predictive maintenance gauge and mapping a gauge value to a perceived correct value by an experienced maintenance personnel so that a better training file for supervised learning may be updated automatically in the field.

In one or more embodiments, a method of on spot machine fault diagnosis through a mobile application may include capturing one or more samples of sound data and image data associated with a machine. The samples of sound and image data may be captured through a mobile device. The samples of sound and image data may be collected onto the mobile application associated with the mobile device. The samples of sound data and image data may be transmitted, over a communications network, to a cloud server. Further, the samples of sound data and image data may be analyzed in combination with an on spot feedback system through the cloud server. The on spot feedback system may be communicatively coupled to a machine-learning engine and a bBig Data architecture. A result of the analysis may be sent to the mobile application associated with the mobile device.

An automated system may include collecting baseline field learning data for various machine conditions. The automated system may use a layered database of subassemblies. Further, the automated system may map predictive maintenance gauge values and automate a training file for a supervised learning system. The supervised learning system may classify machine condition using a Big Data architecture. The Big Data architecture may lead to a large number of mobile applications to be supported real time.

Although the present embodiments have been described with a reference to specific example embodiments, it will be evident that various modifications and changes may be made to these embodiments without departing from the broader spirit and scope of the various embodiments. For example, the various devices and modules described herein may be enabled and operated using hardware circuitry, firmware, software or any combination of hardware, firmware, and software (e.g., embodied in a machine-readable medium). For example, the various electrical structure and methods may be embodied using transistors, logic gates and electrical circuits (e.g. application specific integrated (ASIC) circuitry and/or in Digital Signal Processor (DSP) circuitry).

In addition, it will be appreciated that the various operations, processes and methods disclosed herein may be embodied in a machine-readable medium and/or a machine accessible medium compatible with a data processing system (e.g. a computer devices) and may be performed in any order (e.g. including using means for achieving the various operations). The medium may be, for example, memory or transportable medium such as a CD, a DVD, a Blu-Ray™ disc, a floppy disk, or a diskette. A computer program embodying the aspects of the exemplary embodiments may be loaded onto a retail portal. The computer program is not limited to specific embodiments discussed above and may, for example, be implemented in an operating system, an application program, a foreground or background process, a driver, a network stack or any combination thereof. The computer program may be executed on a single computer processor or multiple computer processors.

Accordingly, the specifications and drawings are to be regarded in an illustrative rather than a restrictive sense.

What is claimed is:

1. A method of on spot machine fault diagnosis through a mobile application comprising:
capturing at least one sample of a sound data and an image data associated with a machine through a mobile device;
collecting the at least one sample of sound data and image data onto the mobile application associated with the mobile device;
transmitting, over a communications network, the at least one sample of sound data and image data through the mobile application to a cloud server;
analyzing the at least one sample of sound data and image data in combination with an on spot feedback system through the cloud server, wherein the on spot feedback system is communicatively coupled to a machine-learning engine and a big data architecture; and
sending a result of the analysis to the mobile application associated with the mobile device.

2. The method of claim 1, further comprising analyzing the at least one sample of sound data and image data through one or more computations.

3. The method of claim 2, wherein a computation engine enables the one or more computations including at least one of a series of entity extraction of vibrational data, RMS, variance and kurtosis of azimuthal angle, peak to RMS ratio, percentiles ratio, ratio of variance of each individual vibration axis.

4. The method of claim 1, wherein an alarm is set through at least one of a rule based engine and a multi-classification machine-learning engine.

5. The method of claim 1,
wherein the result of the analysis is displayed on the mobile application through a user interface dynamic.

6. The method of claim 1,
wherein the user interface dynamic is a predictive maintenance circular gauge;
wherein at least one or more issues associated with the machine are discovered through a machine-learning multi-classification; and wherein the machine-learning multi-classification includes at least one of a neural network, random forest, logistical regression, and support vector machine (SVM).

7. The method of claim 1 wherein the communications network is one of Wi-Fi, 2G, 3G, 4G, GPRS, EDGE, Bluetooth, ZigBee, Piconet of BLE, Zwave or a combination thereof.

8. The method of claim 4, wherein the alarm is raised over the communications network through one of a notification on the mobile application, Short Message Service (SMS), email or a combination thereof.

9. A method of on spot diagnosis of one or more issues associated with a machine, the method comprising:
collecting, through a mobile device, at least one of a sound data and an image data associated with at least one machine;
transmitting the at least one of a sound data and an image data collected at the at least one machine over a communications network to a cloud server, wherein the at least one of a sound data and an image data collected is over a finite time period and transmitted to a machine-learning engine, wherein the cloud server is associated with a machine-learning engine, and wherein the machine-learning engine is associated with a computer database hosting real time and historical data;
analyzing the at least one of sound data and image data in combination with an on spot feedback system through the cloud server, wherein the on spot feedback system is communicatively coupled to the machine-learning engine and a big data architecture;
visualizing, through a user interface dynamic associated with the mobile device, at least one machine issue;
indicating at least one machine issue through a user interface dynamic; and setting an alarm, through a mobile device, for at least one machine issue.

10. The method of claim 9, further comprising of determining at least one machine issue based on one or more computations.

11. The method of claim 10, wherein a computation engine enables the one or more computations.

12. The method of claim 9, wherein the alarm is set through at least one rule based engine and a multi-classification machine-learning engine.

13. The method of claim 9, wherein the user interface dynamic is a predictive maintenance circular gauge.

14. The method of claim 9,
wherein the analysis is based on a comparison of the at least one sound data and image data with a baseline data, and wherein the baseline data is a normal state working data associated with the machine.

15. The method of claim 9, wherein the communications network is one of Wi-Fi, 2G, 3G, 4G, GPRS, EDGE, Bluetooth, ZigBee, Piconet of BLE, Zwave or a combination thereof.

16. The method of claim 9, wherein the alarm is raised over the communications network through one of a notification on the mobile application, Short Message Service (SMS), email or a combination thereof.
